(19) United States
(12) Patent Application Publication
(10) Pub. No.: US 2015/0273903 A1
(43) Pub. Date: Oct. 1, 2015

(54) RECORDING DEVICE, RECORDING SYSTEM, RECORDING MEDIUM, PROGRAM, AND PROGRAM STORAGE MEDIUM

(71) Applicant: SEIKO EPSON CORPORATION, Tokyo (JP)

(72) Inventor: Masanori SAITO, Sapporo-shi (JP)

(21) Appl. No.: 14/667,213

(22) Filed: Mar. 24, 2015

(30) Foreign Application Priority Data
Mar. 28, 2014 (JP) 2014-068232

(51) Int. Cl. B41J 13/26

(52) U.S. Cl. CPC B41J 13/26

(57) ABSTRACT

A recording device includes a printer that records an image on a recording medium, a registration processing part that registers recording control information which is to control the printer in accordance with the recording medium and which is linked to a unique medium ID for each type of recording medium, and a storage unit that stores the registered recording control information.

### BACKGROUND

1. Technical Field

The present invention relates to a recording device, a recording system, a recording medium, a program, and a program storage medium.

2. Related Art

Technical innovation of ink jet printer used as a recording device has progressed and various forms of recording (printing) on various recording (print) media have become possible. As a result, ink jet printers have become to be not only used in offices and homes, but also widely used for commercial-use medium-sized printers for producing a poster, a signboard, promotional materials, wrapping paper, and the like, and for industrial-use large-sized printers that are installed in a production line of products.

In such a situation, while a dedicated ink jet printer specialized for a special recording medium is required, there is a strong need for an ink jet printer that can perform recording in accordance with various recording media (recording media of various materials and various surface conditions) by performing recording control (such as control of discharge parameter of ink droplet, pre-processing on a recording medium, and control of post-processing parameter).

In response to the need, a method has been employed in which a recording evaluation on various recording media is performed in advance and a recording control parameter capable of maintaining a certain recording quality is obtained, and thereafter, the parameter is provided to a user by incorporating the parameter in firmware incorporated in an ink jet printer or incorporating the parameter in driver software that controls the ink jet printer.

On the other hand, JP-A-2005-6055 proposes a printing device including a means that can scan paper on which a recording control parameter (printing control information) (for example, two-dimensional barcode attached to a recording medium) corresponding to each recording medium is printed and use the recording control parameter for printing control of a printer device. Thereby, it is not necessary to replace a ROM included in the printer device, so that it is possible to easily perform a color correction operation optimal for a recording medium.

### SUMMARY

However, the printing device described in JP-A-2005-6055 has a problem that information such as recording control parameters corresponding to recording media and ink jet printers, which become more and more diversified, cannot be included enough in the printing information such as a two-dimensional barcode, that is to say, the amount of information is insufficient. Further, the printing device has a mechanism in which information printed on paper is taken in and used, so that the printing device has a problem that information updated after printing cannot be used, that is, it is not possible to perform recording based on the latest recording control parameter.

An advantage of some aspects of the invention is to solve at least a part of the problems described above and the invention can be implemented as the following application examples or aspects.

### Application Example 1

A recording device according to this application example is characterized to include a recording unit that records an image on a recording medium, a registration processing part that registers recording control information which is to control the recording unit in accordance with the recording medium and which is linked to unique recording medium identification information for each type of the recording medium, and a storage unit that stores the registered recording control information.

According to this application example, the recording device includes the recording unit that records an image on a recording medium, the registration processing part that registers the recording control information (for example, discharge control information of ink droplet in an ink jet printer and pre-processing and post-processing control information for the recording medium) for controlling the recording unit in accordance with the recording medium, and the storage unit that stores the registered recording control information. Further, the recording control information is linked to unique recording medium identification information for each type of recording medium, and the registration processing part registers the recording control information. In other words, it is possible to individually register the recording control information corresponding to each individual recording medium (for each type of recording medium) in the recording device.

### Application Example 2

The recording device according to the aforementioned application example is further characterized in that the recording device includes a display unit and an input unit and the registration processing part changeably displays the recording control information on the display unit based on information inputted from the input unit.

According to this application example, the recording device further includes a display unit and an input unit and the registration processing part changeably displays the recording control information on the display unit based on information inputted from the input unit. Therefore, a user can customize and register the recording control information based on the preference of the user while referring to the recording control information.

### Application Example 3

The recording device according to the aforementioned application example is further characterized in that the recording device includes unique first recording device identification information, the recording control information includes second recording device identification information corresponding to the recording device that can perform recording, and when the first recording device identification information is included in the second recording device identification information, the recording control information is registered.

According to this application example, the recording device includes unique first recording device identification information and the recording control information includes second recording device identification information corresponding to the recording device that can perform recording. The recording device registers the recording control information when the first recording device identification information is included in the second recording device identification information. In other words, the recording control information for a recording medium on which the recording device cannot perform recording is not registered. Only the recording control information for recordable recording media is registered, so that the storage unit is utilized more effectively. Further, the recording control information is linked to unique recording medium identification information for each type of recording medium, so that the user can know the types of recording media on which the recording device can perform recording.

### Application Example 4

The recording device according to the aforementioned application example is further characterized in that the recording control information includes offset information indicating a difference between the recording control information and predetermined recording control information.

According to this application example, the recording control information includes the offset information indicating a difference between the recording control information and the predetermined recording control information. Therefore, when the recording device includes the predetermined recording control information in advance, it is possible to perform recording control corresponding to a recording medium by incorporating the offset information in the recording control information corresponding to each recording medium. In other words, it is not necessary to have all information related to the control of the recording device as the recording control information corresponding to each recording medium, and only the offset information may be held as differential information, so that it is possible to reduce the amount of information.

### Application Example 5

A recording system according to this application example is a recording system in which a recording device and a server are communicably connected through a network. The recording system is characterized in that the recording device includes a recording unit that records an image on a recording medium, a registration processing unit that registers recording control information which is to control the recording unit in accordance with the recording medium and which is linked to unique recording medium identification information for each type of the recording medium, and a storage unit that stores the registered recording control information, the server transmittably stores the recording control information, and the recording device transmits the recording medium identification information of a desired recording medium to the server and receives desired recording control information linked to the recording medium identification information from the server.

The recording system of this application example is a system in which a recording device and a server are communicably connected through a network. The recording device includes the recording unit that records an image on a recording medium, the registration processing unit that registers the recording control information for controlling the recording unit in accordance with the recording medium, and the storage unit that stores the registered recording control information. The server transmittably stores the recording control information. The recording control information is linked to unique recording medium identification information for each type of recording medium, and the recording device transmits the recording medium identification information of a desired recording medium to the server and receives desired recording control information linked to the recording medium identification information from the server. The registration processing part registers the recording control information.

In other words, it is possible to obtain the recording control information corresponding to each individual recording medium (for each type of recording medium) from the server and individually register the recording control information in the recording device. Therefore, it is not necessary to incorporate in advance the recording control information corresponding to various assumed recording media in firmware of an ink jet printer and/or driver software that controls the ink jet printer. For example, even when a recording medium is a recording medium newly added after the recording device is provided to a user, the user can obtain and register the recording control information corresponding to the recording medium as needed. As a result, it is not necessary to revise (upgrade) firmware and/or driver software every time a type of recording medium is added as in a usual manner. Further, the user may obtain and register only the recording control information corresponding to a necessary recording medium when the user needs it.

### Application Example 6

A recording medium according to this application example is a recording medium on which recording is performed by a recording unit included in a recording device. The recording medium is characterized to include unique recording medium identification information linked to recording control information for controlling the recording unit in accordance with the recording medium.

According to this application example, the recording medium includes unique recording medium identification information linked to the recording control information for controlling the recording unit in accordance with the recording medium. Therefore, it is possible to identify the recording control information corresponding to each individual recording medium by the recording medium identification information. In other words, for example, when the recording control information corresponding to various recording media is accumulated in the server communicably connected to the recording device through a network, it is possible to identify and obtain the recording control information linked to the recording medium identification information by using the recording medium identification information as a key, so that the recording medium need not have the recording control information whose amount of information is relatively large. When the recording control information is included in the recording medium, the included recording control information is not updated. However, the recording control information accumulated in the server is linked to the recording medium, so that the user can utilize the latest recording control information by updating the recording control information accumulated in the server to the latest information and maintaining the information.

### Application Example 7

A program according to this application example is a program that operates in a control unit that controls a recording device including a recording unit that records an image on a recording medium, a display unit, an input unit, and a storage unit. The program is characterized to include a registration step of registering recording control information which is to control the recording unit in accordance with the recording medium and which is linked to unique recording medium identification information for each type of the recording medium, and a storage step of storing the registered recording control information in the storage unit.

According to this application example, the program is a program that operates in the control unit that controls the recording device including the recording unit that records an image on a recording medium, the display unit, the input unit, and the storage unit. The program includes the registration step of registering the recording control information for controlling the recording unit in accordance with the recording medium and the storage step of storing the registered recording control information in the storage unit. Further, the recording control information is linked to unique recording medium identification information for each type of recording medium, and the registration step registers the recording control information. In other words, the control unit operates with the program, so that it is possible to individually register the recording control information corresponding to each individual recording medium (for each type of recording medium) in the recording device. Therefore, it is not necessary to incorporate in advance the recording control information corresponding to various assumed recording media in firmware of an ink jet printer and/or driver software that controls the ink jet printer.

### Application Example 8

The program according to the aforementioned application example is further characterized to include a display step of changeably displaying the recording control information on the display unit along with information based on specifications of the recording unit, on the basis of information inputted from the input unit.

According to this application example, the program that operates in the control unit further includes a display step of changeably displaying the recording control information on the display unit along with the information based on the specifications of the recording unit, on the basis of the information inputted from the input unit. Therefore, the user can customize and register the recording control information based on the preference of the user while referring to the recording control information.

### Application Example 9

The program according to the aforementioned application example is further characterized in that the recording device includes unique first recording device identification information, the recording control information includes second recording device identification information corresponding to the recording device that can perform recording, and when the first recording device identification information is included in the second recording device identification information, the registration step registers the recording control information.

According to this application example, the recording device includes the first recording device identification information unique to the recording device and the recording control information includes the second recording device identification information corresponding to the recording device that can perform recording. Further, in the registration step included in the program that operates in the control unit, the recording control information is registered when the first recording device identification information is included in the second recording device identification information. In other words, the recording control information for a recording medium on which the recording device cannot perform recording is not registered. Only the recording control information for recordable recording media is registered (in other words, useless information is not registered in the storage unit), so that the storage unit is utilized more effectively. Further, the recording control information is linked to unique recording medium identification information for each type of recording medium, so that the user can know the types of recording media on which the recording device can perform recording.

### Application Example 10

The program according to the aforementioned application example is further characterized in that the recording control information includes offset information indicating a difference between the recording control information and predetermined recording control information.

According to this application example, the recording control information includes the offset information indicating a difference between the recording control information and the predetermined recording control information. Therefore, when the recording device includes the predetermined recording control information in advance, it is possible to perform recording control corresponding to a recording medium by incorporating the offset information in the recording control information corresponding to each recording medium. In other words, it is not necessary to have all information related to the control of the recording device as the recording control information corresponding to each recording medium, and only the offset information may be held as differential information, so that it is possible to reduce the amount of information.

### Application Example 11

A program storage medium according to this application example is characterized to store the aforementioned program and to be able to be read by a computer.

As in this application example, it is preferable for the program storage medium to store the aforementioned program and to be able to be read by a computer. For example, it is possible to easily and simply cause the control unit to operate by utilizing a computer including an input unit, a display unit, and a storage unit as a control unit and reading the program.

### BRIEF DESCRIPTION OF THE DRAWINGS

The invention will be described with reference to the accompanying drawings, wherein like numbers reference like elements.

FIG. 1 is a block diagram showing a configuration of an example of a recording system according to a first embodiment.

FIG. 2 is a schematic diagram showing a configuration of an example of a printer (recording unit).

FIG. 3A is a conceptual diagram for explaining a usual printer driver. FIG. 3B is a conceptual diagram for explaining recording control information according to the first embodiment.

FIG. 4 is a conceptual diagram showing an example of a relationship between first recording device identification information and second recording device identification information.

FIG. 5 is a conceptual diagram for explaining discharge control information.

FIG. 6 is a conceptual diagram for explaining drive control information.

FIG. 7 is a flowchart of registration processing.

FIG. 8 is a conceptual diagram showing an example of a registration list.

FIG. 9 is a conceptual diagram showing a function of a registration processing part.

FIGS. 10A to 10C are conceptual diagrams for explaining a method of selecting and downloading recording control information registered in a registration list of a server.

### DESCRIPTION OF EXEMPLARY EMBODIMENT

Hereinafter, an embodiment that embodies the invention will be described with reference to the drawings. The embodiment described below is an embodiment of the invention and does not limit the invention. In the drawings described below, components may be drawn in a scale different from the actual scale in order to make the description to be easily understood.

### First Embodiment

### Recording System

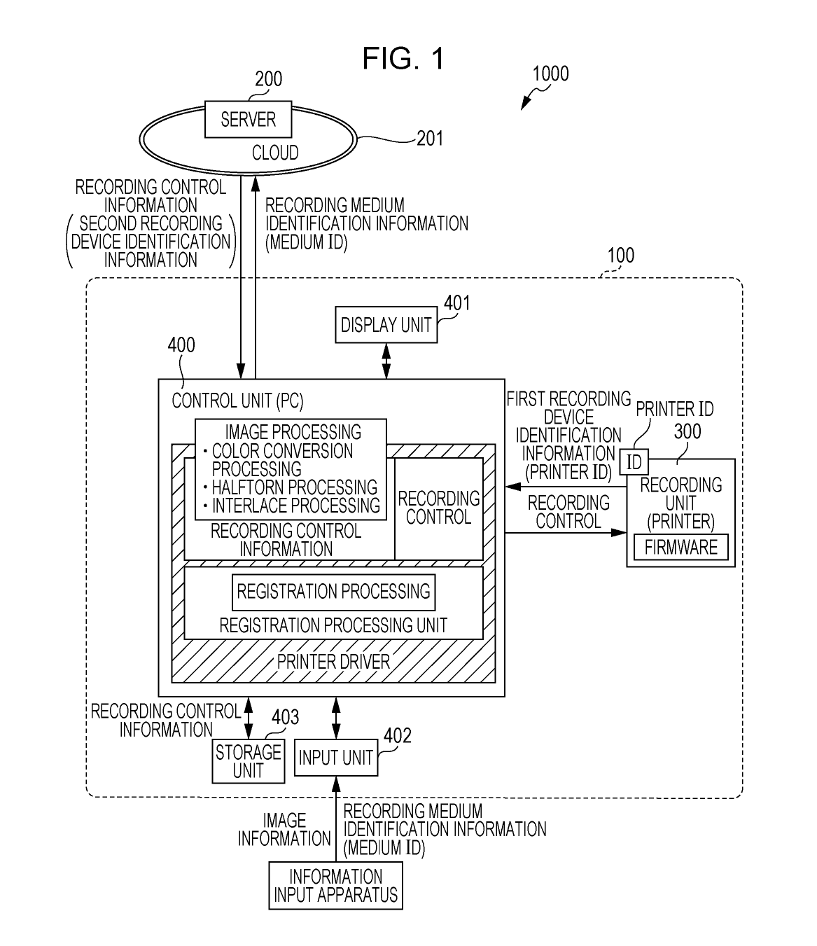

FIG. 1 is a block diagram showing a configuration of a recording system 1000 according to a first embodiment. The recording system 1000 is a system in which a recording device 100 and a server 200 are communicably connected through a network 201. The recording device 100 includes an ink jet type printer 300 as a “recording unit” that records an image on a recording medium and a personal computer 400 (hereinafter referred to as a PC 400) as a “control unit”.

### Server

The server 200 is a network server in so-called cloud computing, which provides information necessary for the recording device 100 through the network 201. The server 200 includes “recording control information” for enabling recording (printing) of predetermined quality in association with a plurality of recording media and a plurality of recording devices 100 (printers 300). Specifically, the recording control information is information for controlling the recording unit (printer 300) such as, for example, discharge control information of ink droplet and control information of pre- and post-processing performed on a recording medium. The recording control information is classified for each individual recording medium and for each recording device that can handle an individual recording medium, and provided. The recording control information will be described later.

### Recording Unit (Printer)

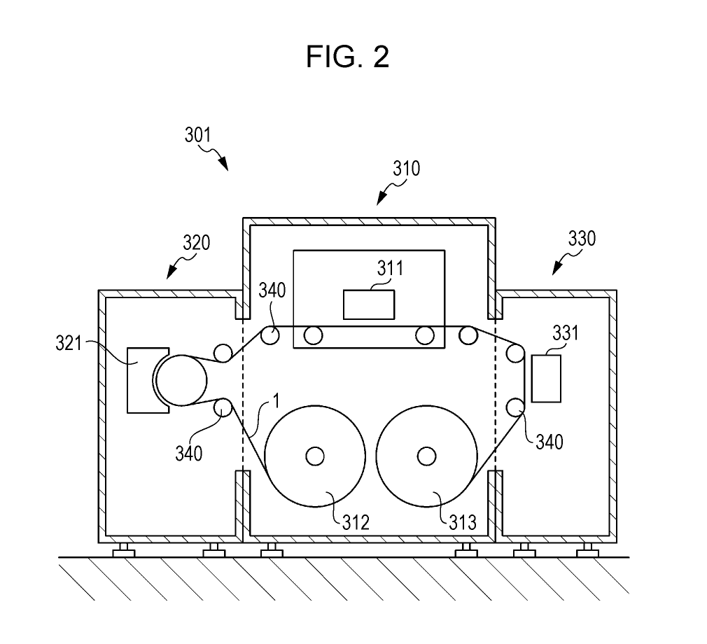

FIG. 2 is a schematic diagram showing a configuration of a printer 301 as an example of the printer 300. The printer 301 is an ink jet type printer that records an image on a roll paper 1 that is supplied in a state in which paper is wound like a roll as a “recording medium” by using, for example, a UV ink containing an ultraviolet curable compound that can be cured by being irradiated with ultraviolet rays. The printer 301 includes a main body 310, a corona treatment unit 320 that performs corona treatment on the roll paper 1 as pre-processing of recording, a UV irradiation unit 330 that performs UV drying as post-processing of recording, and transport rollers 340 that form a transport path. In other words, the printer 301 is an ink jet type printer having a configuration in which the corona treatment unit 320 that improves wettability of the UV ink and the UV irradiation unit 330 that performs UV drying are added to a basic function (the main body 310) that performs recording on the roll paper 1 by using the UV ink.

The main body unit 310 includes an ink discharge unit 311, a supply unit 312, and a winding unit 313. The roll paper 1 is supplied from the supply unit 312, transported through the corona treatment unit 320 and the ink discharge unit 311 by a transport path provided inside the printer 301, and stored in the winding unit 313. The transport rollers 340 are rollers provided at a plurality of positions to form the transport path of the roll paper 1. The transport rollers 340 include drive rollers and driven rollers that are driven by the drive rollers and guide the roll paper 1.

The ink discharge unit 311 includes an ink jet head that discharges the UV ink to a surface of the roll paper 1 and records an image, and an ultraviolet ray irradiation machine (UV irradiation machine) (not shown in the drawings) for temporarily drying (temporarily curing) the discharged UV ink to a degree at which the UV ink does not drip or flow.

The supply unit 312 is a housing unit that houses the roll paper 1 before being recorded. The supply unit 312 is located on the upstream side of the corona treatment unit 320 in the transport path of the roll paper 1. The winding unit 313 is a housing unit that winds and houses the roll paper 1 after being recorded. The winding unit 313 is located on the downstream side of the ink discharge unit 311 in the transport path of the roll paper 1.

The corona treatment unit 320 is arranged on the upstream side of the ink discharge unit 311 in the transport path of the roll paper 1. The corona treatment unit 320 includes a corona discharge electrode 321 that performs corona discharge treatment on the surface of the roll paper 1 before the UV ink is discharged. The UV irradiation unit 330 is arranged on the downstream side of the ink discharge unit 311 in the transport path of the roll paper 1. The UV irradiation unit 330 includes a UV irradiation machine 331 that properly dries the discharged UV ink.

As an example of the printer 300 included in the recording device 100, the printer 301 has been described which has a configuration in which the corona treatment unit 320 that improves the wettability of the UV ink and the UV irradiation unit 330 that performs UV drying are added to the basic function that performs recording on the roll paper 1 by using the UV ink. However, the printer 300 is not limited to such a printer, but various types of printers can be applied.

For example, the ink to be discharged is not limited to the UV ink, but may be a thermosetting ink or a natural drying type ink. In this case, the UV irradiation unit 330 may be provided with, for example, a thermal drying unit including a heater. Further, for example, the recording medium is not limited to the roll paper 1, but may be a sheet type paper. In the case of the sheet type paper, for example, a supply mechanism including a separator for supplying recording media one by one to the ink discharge unit 311 is provided instead of the supply unit 312 and, for example, a storage tray that stores the recording medium discharged from the ink discharge unit 311 after recording is provided instead of the winding unit 313.

Regarding the material of the recording media, for example, high quality paper, cast paper, art paper, and coated paper can be used. Further, the material of the recording media is not limited to the paper media, but for example, synthetic paper, film media formed of PET (Polyethylene terephthalate), PP (polypropylene), and the like, fabric, wooden board, and the like can be used.

As described above, a printer compatible with these various recording media and inks can be applied as the recording unit (printer 300). However, it is necessary to perform recording control corresponding to and suitable for each recording medium and each ink on the printer 300 to which various specifications are applied. To cope with this, a method has been employed in which driver software (hereinafter referred to as a printer driver) that controls hardware and firmware of various types of printers 300 is prepared for each of the printers 300 and the printer driver is installed and used in the PC 400 to which the printer 300 is connected.

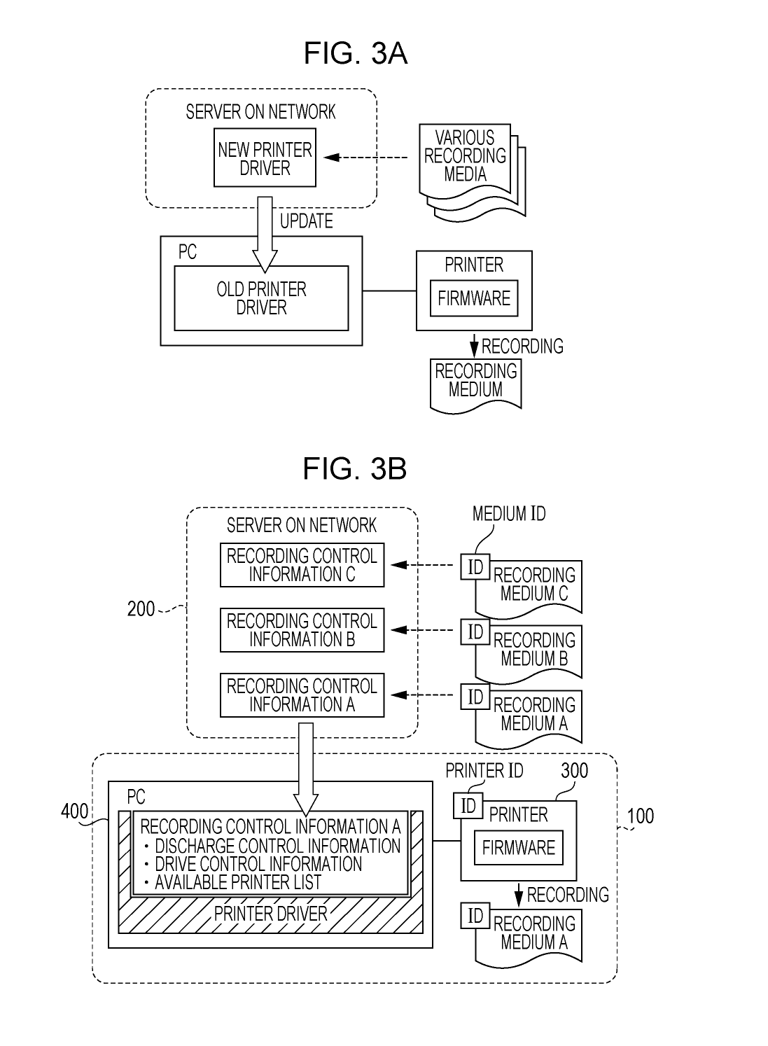

FIG. 3A is a conceptual diagram for explaining a usual printer driver. As shown in FIG. 3A, for example, to enable recording control compatible with various recording media, a method has been employed in which a recording evaluation on various recording media is performed in advance and a parameter for recording control capable of maintaining a certain recording quality is obtained, and thereafter, the parameter is provided to a user by incorporating the parameter in the printer driver. In other words, all parameters for recording media that can be handled are incorporated in the printer driver and then the printer driver is provided. To apply the printer driver to a new recording medium, a method has been employed in which the printer driver is updated based on an evaluation result of the new recording medium and the user installs the updated printer driver in the PC 400.

FIG. 3B is a conceptual diagram for explaining the recording control information of the embodiment. Compared with the usual method described above, the embodiment employs a method in which a parameter for recording control corresponding to each recording medium is prepared as “recording control information” in the server 200 and a user acquires the “recording control information” of a necessary (corresponding) recording medium as needed and installs the “recording control information” in the PC 400. FIG. 3B shows a case in which, for example, recording control information items A to C corresponding to recording media A to C, respectively, are prepared, and when the user performs recording on the recording medium A, the user obtains the recording control information A corresponding to the recording medium A from the server 200 and installs the recording control information A. The correspondence relationship between the recording media A to C and the recording control information items A to C (that is, selection of recording control information corresponding to a recording medium) is determined by “recording medium identification information” (described later) included in each of the recording media A to C.

The PC 400 includes a printer driver in which the recording control information can be incorporated and a user can perform recording on a corresponding recording medium by incorporating the recording control information obtained as needed in the printer driver. Further, the user can change content of the recording control information as needed. Further, the user can register individually obtained recording control information and changed recording control information. Hereinafter, the recording control information will be specifically described.

### Recording Control Information

The recording control information is information for controlling the recording unit (printer 300). The recording control information includes discharge control information, drive control information, and an available printer list used as “second recording device identification information”.

### Discharge Control Information

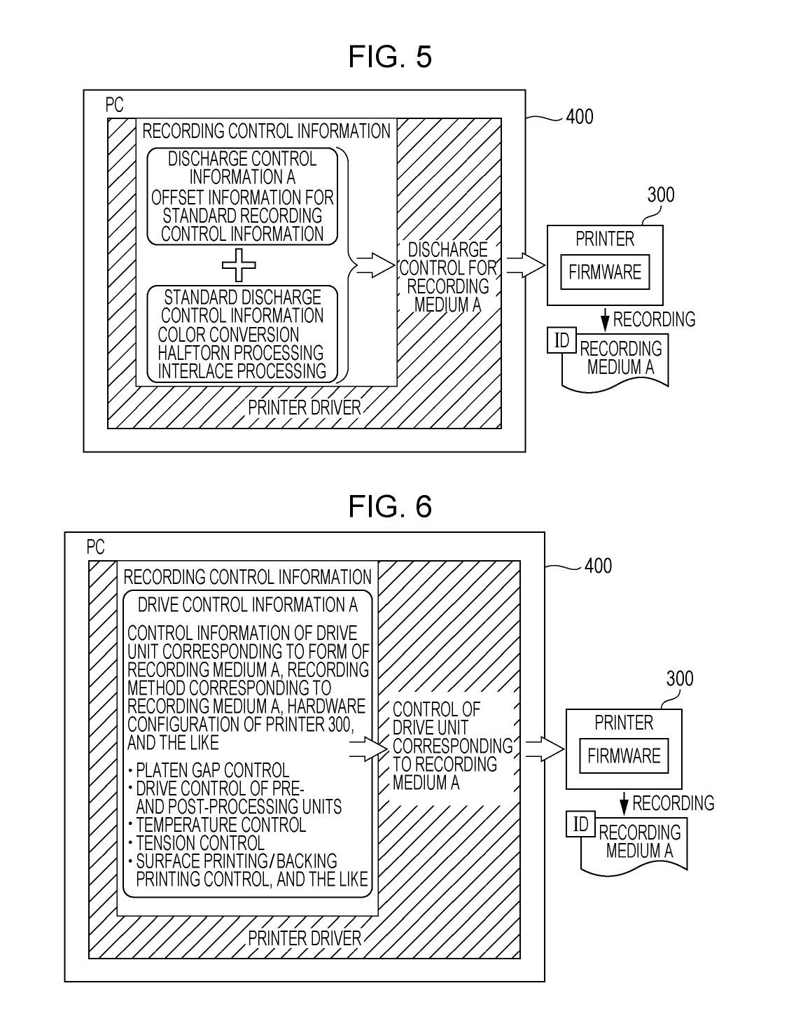

FIG. 5 is a conceptual diagram for explaining the discharge control information. The discharge control information included in the recording control information is control information used when the printer 300 discharges ink droplets to the recording medium. For example, in the printer 301, the discharge control information is used when the ink discharge unit 311 discharges UV ink to the roll paper 1. As illustrated in FIG. 5, the discharge control information includes offset information with respect to discharge control information (standard discharge control information) corresponding to a standard recording medium. The standard discharge control information is included in the recording device 100 in advance. Alternatively, the standard discharge control information can be obtained from the server 200 by using a printer ID of the printer 300 as a key (described later).

The standard recording medium is a recording medium that is set for each recording usage in advance and is a recording medium suitable for the recording usage and a standard ink applied to the usage. The standard discharge control information is a discharge control parameter that is set in advance as an optimal condition by performing an evaluation of recording on the standard recording medium. The discharge control parameter is, specifically, a conversion parameter for performing color conversion processing, halftone processing, and interlace processing. In other words, the discharge control information included in the recording control information includes offset values indicating a difference from each of the standard conversion parameters which are used for performing the color conversion processing, the halftone processing, and the interlace processing and which are set as an optimal condition in advance. For example, in the case of the color conversion processing, RGB data of image information to be recorded is converted into standard ink amount data of each of cyan (C), magenta (M), yellow (Y), and black (K) based on a standard look-up table prepared for the standard discharge control information. The converted CMYK standard ink amount data is corrected to appropriate CMYK ink amount data by using offset values indicating differences from the standard conversion parameters. The standard look-up table may be corrected to an appropriated look-up table by the offset values indicating differences from the standard conversion parameters, and the RGB data of image information may be converted into the appropriate CMYK ink amount data based on the appropriated look-up table.

### Drive Control Information

FIG. 6 is a conceptual diagram for explaining the drive control information. The drive control information included in the recording control information is control information of a drive unit that acts on the recording medium. For example, in the printer 301, the drive control information corresponds to control information of the corona treatment on the roll paper 1 (drive control information of the corona treatment unit 320) and drive control information of the UV irradiation unit 330 that performs UV drying. The drive control information includes various information depending on a form of the recording medium, a recording method, a hardware configuration of the printer 300, and the like. As the drive control information, for example, there are information of platen gap control with respect to the thickness of the recording medium (in the case of the printer 301, information of control of a distance between a nozzle surface of the ink discharge unit 311 and a surface of the roll paper 1), information of a drive parameter of the pre-processing unit (in the printer 301, the presence or absence of the corona treatment or the strength of the corona treatment) when it is assumed that pre-processing is required to be performed on the recording medium, and information of a drive parameter of the post-processing unit (in the printer 301, the presence or absence of irradiation of the UV irradiation machine 331 and the strength of the irradiation) when it is assumed that post-processing is required to be performed on the recording medium. Other examples of the drive control information include heating temperature information used when performing heating treatment, tension (tensile force) information in the transport path of the recording medium, and ink discharge order (surface printing/backing printing) information for a transparent recording medium. In this way, the drive control information can be added as new information depending on a form of a newly added recording medium, a recording method, and a configuration of the printer 300.

### Second Recording Device Identification Information (Available Printer List)

The available printer list used as the “second recording device identification information” included in the recording control information is list information (list of printer IDs) of printers 300 that can perform recording on the recording medium. In other words, the available printer list is a model list of printers that can perform recording on the recording medium while maintaining a certain recording quality by using the recording control information corresponding to the recording medium. For example, the list does not include printers 300 that cannot perform recording by only recording control due to the type of the recording medium (a form such as rolled paper and cut sheet, and material such as fabric and film).

### Recording Medium Identification Information (Medium ID)

Linkage between each recording medium and the recording control information corresponding to the recording medium can be made by the recording medium identification information included in each recording medium. The recording medium identification information includes a code (hereinafter referred to as a medium ID) such as a symbol and a number uniquely given to each type of recording medium. Further, the recording medium identification information may include, for example, a user-friendly name, a production time, a production region, and a production lot number in addition to the medium ID. The information such as the production time, the production region, and the production lot number can be utilized as effective information when it is preferable to change recording condition due to production variation of the recording medium depending on the type of the recording medium. As a method of attaching the recording medium identification information, for example, characters, symbols, a barcode, or the like that represent the recording medium identification information are printed on a packing material for packing recording media, a document included in the recording media, or a label attached to these. As described above, each of the discharge control information, the drive control information, and the available printer list, which are included in the recording control information, is unique information corresponding to an individual recording medium, and a user can obtain desired recording control information from the server 200 by using the medium ID as a key.

### First Recording Device Identification Information (Printer ID)

The content, method, and specifications of the recording control vary depending not only on the recording medium, but also on the ink for recording and the printer 300 corresponding to the recording medium and the ink. Therefore, the recording device 100 includes first recording device identification information unique to the recording device 100. The first recording device identification information is a code (hereinafter referred to as a printer ID) such as a symbol and a number uniquely given to each type of the printer 300 included in the recording device 100. Further, the first recording device identification information may include, for example, a user-friendly printer name, a production time of the printer, and a production lot number in addition to the printer ID. It is possible to determine whether or not recording can be performed on a recording medium linked to the recording control information by searching the aforementioned available printer list included in the recording control information for the printer ID included in the recording device 100 (the printer 300 included in the recording device 100).

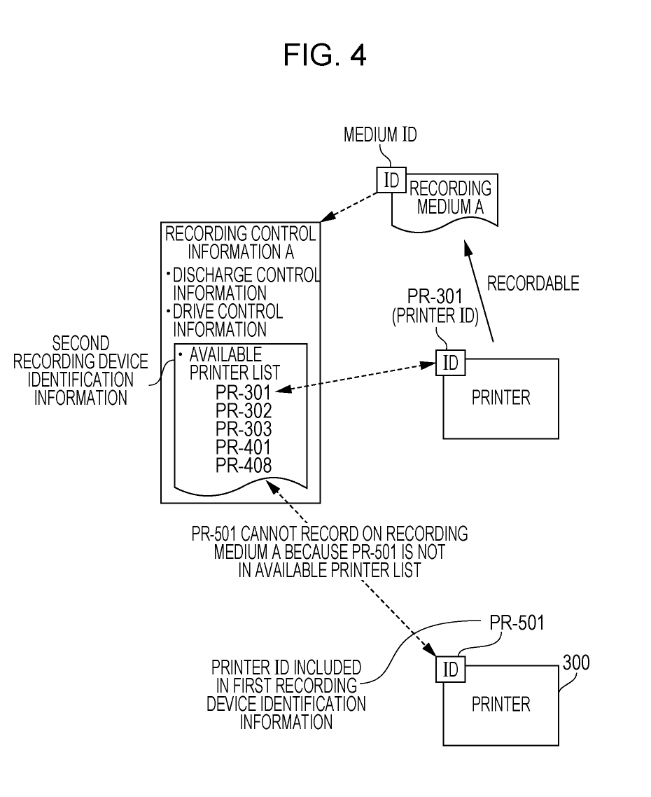

FIG. 4 is a conceptual diagram showing an example of a relationship between the first recording device identification information and the second recording device identification information (the available printer list). The available printer list of the recording control information A corresponding to the recording medium A includes PR-301, PR-302, PR-303, PR-401, and PR-408 as a list of printer IDs. Therefore, the printer 300 having the PR-301 as the printer ID can perform recording on the recording medium A by using the recording control information A. However, the printer 300 having PR-501 as the printer ID cannot perform recording on the recording medium A even when using the recording control information A corresponding to the recording medium A.

### Control Unit (PC 400)

Let us return to FIG. 1. The PC 400 will be described. The PC 400 includes a display unit 401, an input unit 402, and a storage unit 403, and controls the printer 300 and the entire recording device 100. The display unit 401 is an information display means (display) used as a human interface and displays information inputted from the input unit 402, image information to be recorded in the printer 300, control information of the printer 300 based on the recording control information, and the like under control of the PC 400. Input unit 402 is an information input means used as a human interface. Specifically, the input unit 402 is, for example, a port to which a keyboard and an information input apparatus are connected. The storage unit 403 is a rewritable storage medium such as a hard disk drive (HDD) and a memory card. The storage unit 403 stores software (program) operated by the PC 400, the recording control information, image information, and the like.

### Function of Control Unit (PC 400)

The PC 400 has a function to cause the printer 300 to record a desired recording image inputted from outside through the input unit 402 or the network 201 on the recording medium. Specifically, the PC 400 has an image processing function, a recording control function, and a registration processing function of the recording control information.

### Image Processing Function

Regarding the image processing function, the PC 400 has an image processing function realized by general application software that processes information of a recording image (for example, general RGB digital image information) inputted from outside and functions (such as the color conversion processing, the halftone processing, and the interlace processing) to convert information of recording image for drive-controlling the printer 300. The color conversion processing is processing for converting RGB color data into CMYK color data. The CMYK is a color mode using cyan (C), magenta (M), yellow (Y), and black (K). The halftone processing and the interlace processing are processing (binarization processing, array processing, and the like) for converting CMYK image information into dot information for actually discharging ink from each nozzle included in the ink discharge unit 311.

### Recording Control Function

The recording control function is a function for drive-controlling the printer 300 based on the recording control information. The recording control function performs ink discharge control, movement/transportation control of the recording medium, control of pre-processing and post processing, and processing of information sent from the printer 300. The recording control (the drive control of the printer 300) may be performed in a manner in which the printer 300 is driven by firmware included in the printer 300 based on the recording control of the PC 400 or may be performed in a manner in which the printer 300 is driven by both firmware included in the PC 400 and firmware included in the printer 300.

### Registration Processing Function

The registration processing function is a function used as a “registration processing part” that registers the recording control information linked to the medium ID (the recording medium identification information). The registered recording control information is stored in the storage unit 403.

### Recording Control Program

The image processing function and the recording control function that are performed by the PC 400 based on the recording control information, and a function for performing registration processing as the registration processing part between the PC 400 and a user are performed by a program of the PC 400 stored in the storage unit 403. The program (hereinafter referred to as a recoding control program) is supplied as a part of the function of the printer driver to the user through a program storage medium that can be read by a computer (PC 400 and the like) or the network 201. Examples of the “program storage medium” include an optical disk (compact disk (CD)), a digital versatile disk (DVD), a Blu-ray Disc (BD), a laser disk (registered trademark) (LD)), a magnet-optical disk (MO), a magnetic disk (hard disk drive (HDD)), a flexible disk (FD), a magnetic tape (digital data storage (DDS)), and a memory (flash memory, memory card, and USB memory).

The recording control program includes a display step, a registration step, and a storage step. The “display step” is a step of changeably displaying the recording control information obtained individually on the display unit 401 along with information based on the specifications of the printer 300, on the basis of information inputted from the input unit 402. The “registration step” is a step of registering the recording control information obtained individually and the recording control information that is changed. The “storage step” is a step of storing the registered recording control information in the storage unit 403.

### Registration Processing

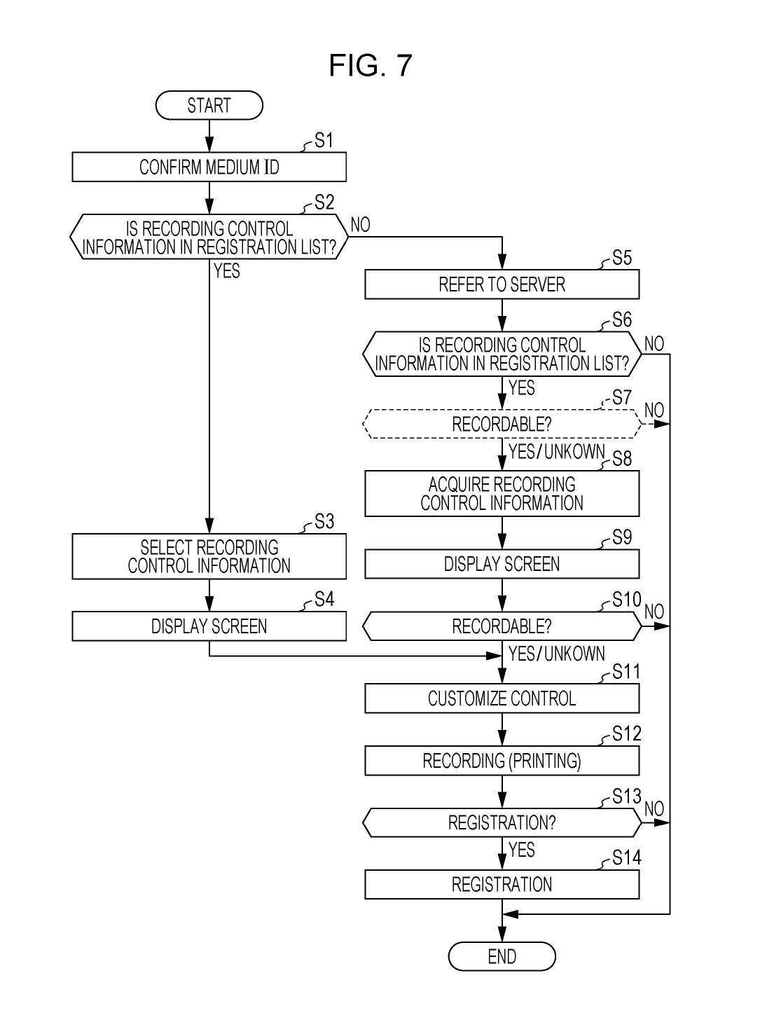

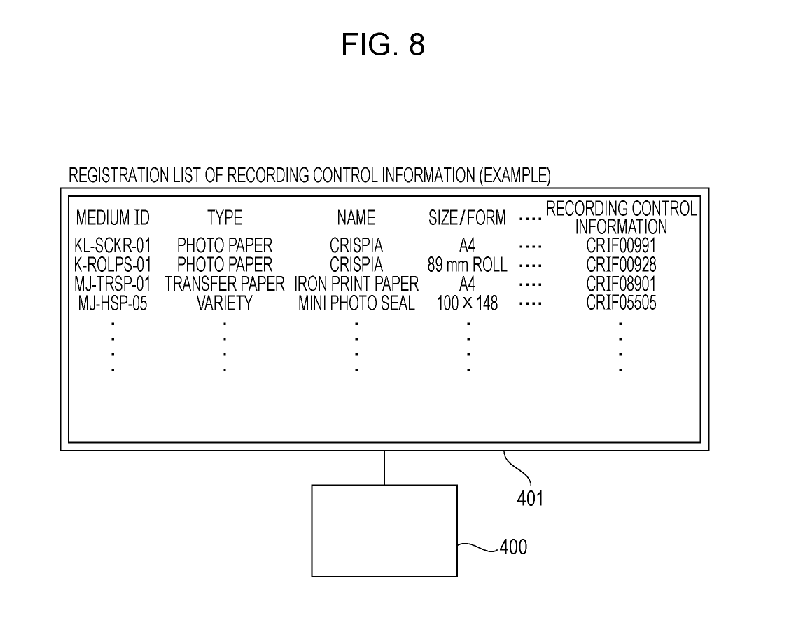

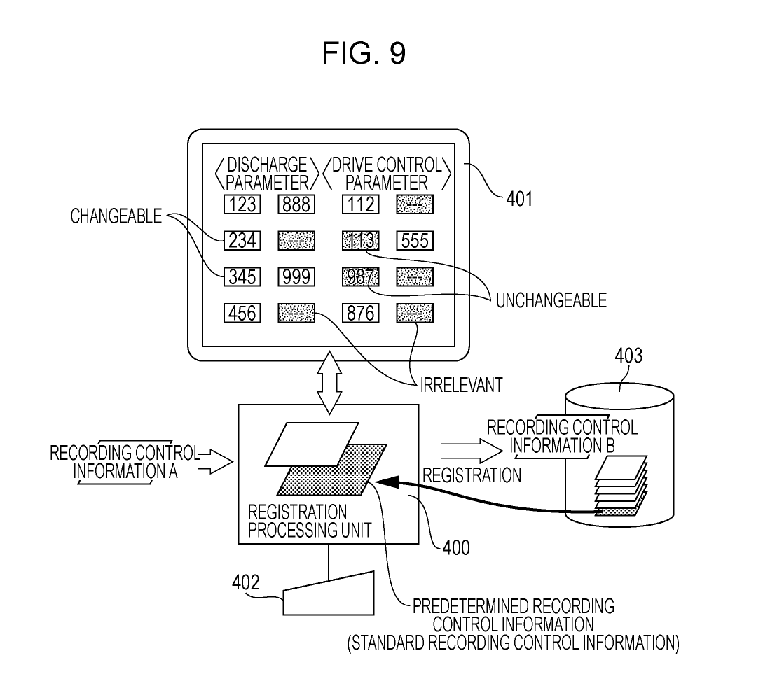

FIG. 7 is a flowchart of the registration processing. FIG. 9 is a conceptual diagram showing a function of the registration processing part. A series of processing will be described with reference to FIG. 9 according to the flowchart of FIG. 7. First, a user confirms the medium ID of the recording medium on which recording is performed by the recording device 100 (step S1). Subsequently, the user starts the recording control program and checks whether or not the recording control information corresponding to the recording medium is registered in the recording device 100 (stored in the storage unit 403) by using a registration list in order to perform recording control suitable for the recording medium (step S2). As illustrated by an example in FIG. 8, the registration list is a list of medium IDs and names of the recording media, which are linked to the registered recording control information. The registration list is updated every time the registered recording control information is stored in the storage unit 403.

If the recording control information has already been registered, the user selects corresponding recording control information from the registration list (step S3). The recording control program reads the selected recording control information from the storage unit 403 along with standard recording control information, and displays parameters for drive-controlling the printer 300 on the display unit 401 on the basis of the standard recording control information and the recording control information (by calculating offset information) (step S4). At this time, as shown in FIG. 9, the parameters are displayed as changeable parameters, unchangeable parameters, and irrelevant parameters, which are displayed in different manners, respectively (display step). The user can change a changeable parameter to a desired value from the input unit 402, so that the user can customize the control (step S11).

The changeable parameter is a parameter that can be changed according to user's preference. However, it is preferable to limit a change range to an appropriate range in advance. In other words, it is preferable that the recording control information includes information of a changeable range regarding the changeable parameter. A typical example of the changeable parameter of a discharge parameter is, for example, RGB color balance. The irrelevant parameter is, for example, a parameter by which no object is controlled. For example, when a UV ink printer that does not include the corona treatment unit 320 is used, a control parameter of the corona treatment (corona treatment intensity and the like) is an irrelevant parameter. In this way, regarding the changeable/unchangeable and the relevant/irrelevant, a corresponding display is performed according to the specifications of the printer 300 and the specifications of the recording medium.

Subsequently, recording is performed according to the recording control information customized as needed (step S12). It is possible to change content of customization as needed according to a result of the recording. It is determined whether or not the customized recording control information should be registered (step S13), and when the customized recording control information is registered, it is possible to register again the customized recording control information by changing, for example, the medium ID and the name of recording medium (step S14, registration step). At the same time as the registration, the recording control information is stored in the storage unit 403 (storage step).

On the other hand, in step S2, when the recording control information corresponding to the recording medium is not registered in the recording device 100, the server 200 is referred to (step S5). The reference to the server 200 is automatically performed by the PC 400 under confirmation of the user (for example, an access to a corresponding database in the server 200 through the network 201). It is determined whether or not the recording control information is registered in a registration list in the server 200 by referring to the server 200 (step S6), and when the recording control information is registered, corresponding recording control information is selected and downloaded under confirmation of the user (step S8). The registration list in the server 200 is a list of medium IDs and names of recording media, which are linked to the recording control information registered in the server 200.

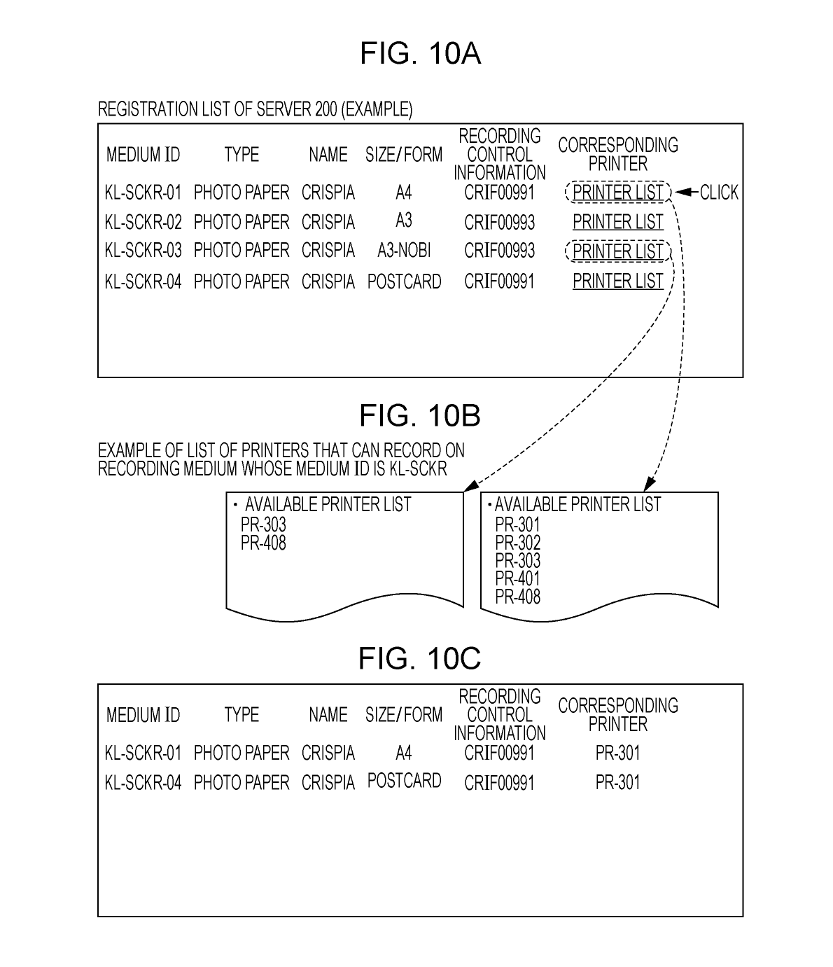

FIG. 10A illustrates a list of pieces of recording control information hit as a result of performing search by using, for example, “KL-SCKR” as a key of the medium ID. FIG. 10A shows that the media corresponding to the medium ID “KL-SCKR” are four types of KL-SCKR-01 to KL-SCKR-04 according to the sizes of the media, and there are four types of media KL-SCKR-01 to KL-SCKR-04 corresponding to the medium ID “KL-SCKR” according to the sizes of the media, and there are two types of recording control information “CRIF00991” and “CRIF00993” according to the printers 300 that can handle the sizes. When the user clicks an item “printer list” of a corresponding printer in a row corresponding to each piece of recording control information, a list of corresponding printers is displayed as shown in FIG. 10B. For example, for “CRIF00991”, a list of printers 300 that can handle paper up to A4 size is displayed, and for “CRIF00993”, a list of printers that can handle paper up to A3-NOBI size is displayed. Here, for example, the printer ID “PR-301” indicates a printer that can handle paper up to A4 size, and the printer ID “PR-303” indicates a printer that can handle paper up to A3-NOBI size.

Here, the search for the presence or absence of the corresponding recording control information is performed by using the medium ID as a key. However, the search may be performed by using, for example, the printer ID along with the medium ID. As described above, the recording control information includes a printer ID list of available printers 300 as the “second recording device identification information”, so that when a printer ID as the key information is not included in the list, it can be determined that recording cannot be performed or no recording has been performed (step S7). In other words, it can be selected not to perform useless downloading.

Specifically, for example, in the case of the example of FIG. 10A, when the search is performed by using, for example, the “KL-SCKR” as the medium ID and the “PR-301” as the printer ID, as shown in FIG. 10C, only the recording control information (in the case of FIG. 10C, only CRIF00991) corresponding to the printers that can perform recording is displayed, so that it can be selected not to perform useless downloading (for example, downloading of the recording control information CRIF00993).

Subsequently, based on the downloaded recording control information and the standard recording control information (by calculating the offset information), parameters for drive-controlling the printer 300 are displayed on the display unit 401 (step S9). At this time, it is determined whether or not the printer ID of the printer 300 is included in the printer ID list of the available printers of the downloaded recording control information, and when the printer ID is not included, it is determined that the printer 300 cannot perform recording and the registration processing is ended under confirmation of the user (step S10).

When the user determines that recording becomes possible by changing the parameters, it is possible to configure so that the registration processing is not ended and the process can proceed to the next customization processing (step S11). However, in this case, it is preferable to give warning to the user, such as changing the display on the display unit 401 to a display different from that in normal processing.

When the printer ID of the printer 300 is included in the printer ID list of the available printers of the downloaded recording control information, in the same manner as in step S4, as shown in FIG. 9, the parameters are displayed as changeable parameters, unchangeable parameters, and irrelevant parameters, which are displayed in different manners, respectively (display step). The user can change a changeable parameter to a desired value from the input unit 402, so that the user can customize the control (step S11).

Recording is performed according to the recording control information customized as needed (step S12). It is possible to change content of customization as needed according to a result of the recording. Subsequently, it is determined whether or not the recording control information should be registered (step S13), and when the recording control information is registered, the recording control information is registered by changing, for example, the medium ID and the name of recording medium as needed (step S14, registration step). At the same time as the registration, the recording control information is stored in the storage unit 403 (storage step).

FIG. 9 shows an operation in which content obtained by customizing the downloaded recording control information A by changing the parameters displayed on the display unit 401 in the PC 400 (the registration processing part) is registered as the recording control information B and stored in the storage unit 403. Here, the registered recording control information B includes offset information calculated by using the customized parameters and the standard recording control information.

### Effects on Embodiment

As described above, according to the recording device, the recording system, the recording medium, the program, and the program storage medium of the embodiment, the following effects can be obtained. The recording device 100 includes the printer 300 that records an image on a recording medium, the registration processing part (the PC 400) that registers the recording control information for controlling the printer 300 in accordance with the recording medium, and a storage unit 403 that stores the registered recording control information. The recording control information is linked to a unique medium ID for each type of recording medium, and the registration processing part registers the recording control information. In other words, the recording control information corresponding to each individual recording medium (for each type of recording medium) can be individually registered in the recording device 100 based on the specifications of the printer 300. Therefore, it is not necessary to incorporate in advance the recording control information corresponding to various assumed recording media in the firmware of the printer 300 and/or the driver software that controls the printer 300.

The recording device 100 further includes the display unit 401 and the input unit 402, and the registration processing part changeably displays the recording control information along with the information based on the specifications of the printer 300 on the display unit 401 on the basis of the information inputted from the input unit 402. Therefore, a user can customize and register the recording control information based on the preference of the user while referring to the recording control information.

The recording device 100 includes the printer ID of the printer 300 included in the recording device 100 as unique recording device identification information, and the recording control information includes list information of printer IDs corresponding to the recording devices 100 that can perform recording. The recording device 100 registers the recording control information when the printer ID of the printer 300 is included in the printer ID list of the available printers. In other words, the recording control information for recording media on which the recording device 100 (the printer 300) cannot perform recording is not registered. Only the recording control information for recordable recording media is registered (in other words, useless information is not registered in the storage unit 403), so that the storage unit 403 is utilized more effectively. The recording control information is linked to a unique medium ID for each type of recording medium, so that the user can know the types of recording media on which the recording device 100 can perform recording.

The recording control information includes the offset information indicating the difference between the recording control information and predetermined recording control information (standard recording control information). Therefore, when the recording device 100 includes the standard recording control information in advance, it is possible to perform recording control corresponding to a recording medium by incorporating the offset information in the recording control information corresponding to each recording medium. In other words, it is not necessary to have all information related to the control of the recording device 100 as the recording control information corresponding to each recording medium, and only the offset information may be held as differential information, so that it is possible to reduce the amount of information. Further, for example, when it is desired to change specifications of control of the recording device 100 in common to a plurality of recording media, only the standard recording control information held in advance by the recording device 100 has to be changed.

The recording system 1000 is a system in which the recording device 100 and the server 200 are communicably connected through the network 201. The server 200 transmittably stores a plurality of pieces of recording control information. The recording device 100 transmits the medium ID of a desired recording medium to the server 200 and receives desired recording control information linked to the medium ID from the server 200. The registration processing part registers the recording control information. In other words, it is possible to obtain the recording control information corresponding to each individual recording medium (for each type of recording medium) from the server 200 and individually register the recording control information in the recording device 100. Therefore, the recording control information corresponding to various assumed recording media need not be incorporated in advance in the firmware of the printer 300 and/or the driver software that controls the printer 300. For example, even when a recording medium is a recording medium newly added after the recording device 100 is provided to a user of the recording device 100, the user can obtain and register the recording control information corresponding to the recording medium as needed. As a result, it is not necessary to revise (upgrade) firmware and/or driver software every time a type of recording medium is added as in a usual manner. Further, the user may obtain and register only the recording control information corresponding to a necessary recording medium when the user needs it.

Further, a recording medium includes a unique medium ID linked to the recording control information for controlling the printer 300 in accordance with the recording medium. Therefore, it is possible to identify the recording control information corresponding to each individual recording medium by the medium ID. When the recording control information corresponding to various recording media is accumulated in the server 200 communicably connected to the recording device 100 through the network 201, it is possible to obtain the recording control information linked to a medium ID by using the medium ID as a key, so that a recording medium need not have the recording control information whose amount of information is relatively large. When the recording control information is included in a recording medium, the recording control information is not updated, but the recording control information accumulated in the server 200 is linked to the recording medium, so that the user can utilize the latest recording control information by updating the recording control information accumulated in the server 200 to the latest information.

The recording control program is a program that operates in the control unit that controls the recording device 100 including the printer 300 that records an image on a recording medium, the display unit 401, the input unit 402, and the storage unit 403. The recording control program includes a registration step of registering the recording control information for controlling the printer 300 corresponding to a recording medium and a storage step of storing the registered recording control information in the storage unit 403. The recording control information is linked to a unique medium ID for each type of recording medium, and the registration step registers the recording control information. In other words, it is possible to individually register the recording control information corresponding to each individual recording medium (for each type of recording medium) in the recording device 100. Therefore, it is not necessary to incorporate in advance the recording control information corresponding to various assumed recording media in the firmware of the printer 300 and/or the driver software that controls the printer 300.

The recording control program includes a display step of changeably displaying the recording control information on the display unit 401 along with information based on the specifications of the printer 300, on the basis of information inputted from the input unit 402. Therefore, the user can customize and register the recording control information based on the preference of the user while referring to the recording control information.

The program storage medium stores the recording control program described above, and a computer can read the recording control program stored in the program storage medium. Therefore, the PC 400 can easily and simply exert the control function of the recording device 100 by reading the recording control program.

The entire disclosure of Japanese Patent Application No. 2014-68232, filed Mar. 28, 2014 is expressly incorporated by reference herein.

What is claimed is:

1. A recording device comprising:
a recording unit that records an image on a recording medium;
a registration processing part that registers recording control information which is to control the recording unit in accordance with the recording medium and which is linked to unique recording medium identification information for each type of the recording medium; and
a storage unit that stores the registered recording control information.

2. The recording device according to claim 1, further comprising:
a display unit; and
an input unit,
wherein the registration processing part changeably displays the recording control information on the display unit based on information inputted from the input unit.

3. The recording device according to claim 1, further comprising
unique first recording device identification information,
wherein the recording control information includes second recording device identification information corresponding to the recording device that can perform recording, and
when the first recording device identification information is included in the second recording device identification information, the recording control information is registered.

4. The recording device according to claim 1, wherein the recording control information includes offset information indicating a difference between the recording control information and predetermined recording control information.

5. A recording system in which a recording device and a server are communicably connected through a network, wherein
the recording device includes
a recording unit that records an image on a recording medium,
a registration processing part that registers recording control information which is to control the recording unit in accordance with the recording medium and which is linked to unique recording medium identification information for each type of the recording medium, and
a storage unit that stores the registered recording control information,
the server transmittably stores the recording control information, and
the recording device transmits the recording medium identification information of a desired recording medium to the server and receives desired recording control information linked to the recording medium identification information from the server.

6. A recording medium on which recording is performed by a recording unit included in a recording device, the recording medium comprising:
unique recording medium identification information linked to recording control information for controlling the recording unit in accordance with the recording medium.

7. A program that operates in a control unit that controls a recording device including a recording unit that records an image on a recording medium, a display unit, an input unit, and a storage unit, the program comprising:
a registration step of registering recording control information which is to control the recording unit in accordance with the recording medium and which is linked to unique recording medium identification information for each type of the recording medium; and
a storage step of storing the registered recording control information in the storage unit.

8. The program according to claim 7, further comprising
a display step of changeably displaying the recording control information on the display unit along with information based on specifications of the recording unit, on the basis of information inputted from the input unit.

9. The program according to claim 7, wherein
the recording device includes first recording device identification information unique to the recording device,
the recording control information includes second recording device identification information corresponding to the recording device that can perform recording, and
when the first recording device identification information is included in the second recording device identification information, the registration step registers the recording control information.

10. The program according to claim 7, wherein the recording control information includes offset information indicating a difference between the recording control information and predetermined recording control information.

11. A program storage medium which stores the program according to claim 7 and which can be read by a computer.

12. A program storage medium which stores the program according to claim 8 and which can be read by a computer.

13. A program storage medium which stores the program according to claim 9 and which can be read by a computer.

14. A program storage medium which stores the program according to claim 10 and which can be read by a computer.
